(19) United States
(12) Patent Application Publication
(10) Pub. No.: US 2018/0071578 A1
(43) Pub. Date: Mar. 15, 2018

(54) WEARABLE AUGMENTED REALITY DEVICE FOR GOLF PLAY

(71) Applicant: JETSTRON TECHNOLOGIES CO., LTD., Kaohsiung City (TW)

(72) Inventor: Chien-Hao CHU, Kaohsiung City (TW)

(21) Appl. No.: 15/422,836

(22) Filed: Feb. 2, 2017

(30) Foreign Application Priority Data
Sep. 10, 2016 (TW) 105129422

(51) Int. Cl. A63B 24/00; A63B 71/06

(52) U.S. Cl. CPC A63B 24/0021; A63B 71/0619; H04W 76/02; A63B 2024/0034; A63B 2071/0647; A63B 2220/806

(57) ABSTRACT

A wearable augmented reality device for golf play assists a golfer who plays golf with a ball and a club, and includes a camera, a memory, a processor and a display. The camera captures an image of the ball and the club so as to obtain a captured image. The memory stores an image recognition module and an image calculation module. The processor executes the image recognition module so as to recognize the ball and the club in the captured image, to execute the image calculation module so as to determine whether the ball is hit by the club according to a positional relationship between the ball and the club in the captured image, and to calculate flight information of the ball to be displayed by the display when it is determined that the ball is hit by the club.

### CROSS-REFERENCE TO RELATED APPLICATION

This application claims priority of Taiwanese Patent Application No. 105129422, filed on Sep. 10, 2016.

### FIELD

The disclosure relates to a wearable augmented reality device, and more particularly to a wearable augmented reality device for assisting a golfer.

### BACKGROUND

A golfer usually learns correspondences between clubs and carries from practical experience accumulated during golf plays, and often estimates an actual carry based on distance markers placed in a driving range or by seeking an estimation from a caddie. However, departure of such estimations from reality may mislead the golfer into using an unsuitable club for a shot.

Additionally, a golfer who is unfamiliar with a golf course needs more information about the golf course in order to efficiently play a game.

### SUMMARY

Therefore, an object of the disclosure is to provide a wearable augmented reality device for golf play that can alleviate at least one of the drawbacks of the prior art.

According to the disclosure, the wearable augmented reality device for golf play is to be used for assisting a golfer who plays golf with a ball and a club. The wearable augmented reality device includes a camera, a memory, a processor and a display. The camera is configured to capture an image of the ball and the club which is swung by the golfer for hitting the ball so as to obtain a captured image. The memory is configured to store an image recognition module and an image calculation module. The processor is configured to execute the image recognition module so as to recognize the ball and the club in the captured image, to execute the image calculation module so as to determine whether the ball is hit by the club according to a positional relationship between the ball and the club in the captured image, to calculate flight information of the ball when it is determined that the ball is hit by the club, and to output the flight information. The display is configured to display the flight information received from the processor.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary schematic view illustrating an embodiment of a wearable augmented reality device for golf play according to the disclosure;

FIG. 2 is a fragmentary schematic view illustrating that an image displayed and an actual club can be seen at the same time by a golfer who wears the embodiment;

FIG. 3 is a block diagram illustrating an embodiment of the wearable augmented reality device;

FIG. 4 is a schematic diagram illustrating a wireless communication ability of the embodiment;

FIG. 5 is a flow chart illustrating an operation procedure of using the embodiment;

FIG. 6 is a schematic diagram illustrating that the golfer who wears the embodiment can simultaneously see an actual view of a golf course and information displayed by a display which includes performance indication, green information, obstacle information and a club recommendation; and

FIG. 7 is another schematic diagram illustrating that the golfer who wears the embodiment can simultaneously see the actual view of the golf course and information displayed by the display which includes the performance indication, the green information, flight information, and a set of club specifications of the club that is actually used.

### DETAILED DESCRIPTION

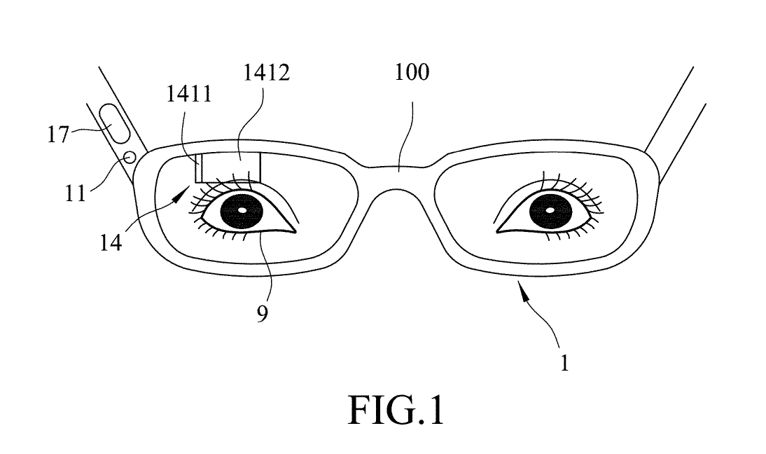

Referring to FIGS. 1, 2 and 6, an embodiment of a wearable augmented reality device 1 for golf play which is used to assist a golfer 9 who plays golf with a ball (not shown) and a club 8 at a golf course 7 including a green 74 is illustrated. The club 8 may have an identification 81 in the form of a visual presentation thereon.

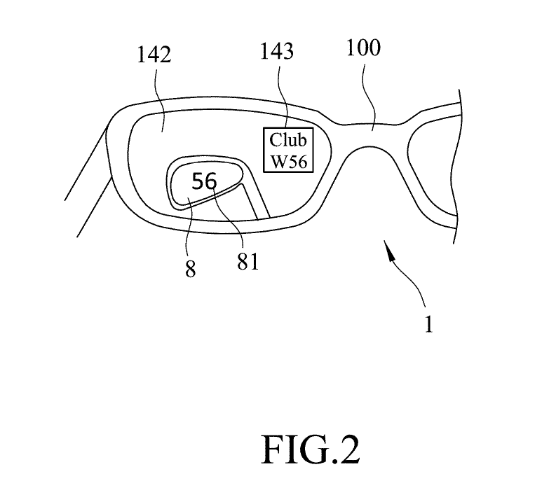

Referring to FIGS. 1-3, the embodiment of the wearable augmented reality device 1 has an appearance resembling a pair of glasses as shown in FIGS. 1 and 2, and includes a frame 100, a battery 10 disposed on the frame 100, a camera 11, a memory 12, a processor 13, a display 14, a positioning unit 151, a direction finder 152, a laser scanner 16, a touch module 17, a wireless communication module 18, a microphone 192 and a loudspeaker 191.

The battery 10 is configured to supply electrical energy for the embodiment of the wearable augmented reality device 1 of the disclosure.

The camera 11 is configured to capture an image of at least one of the ball or the club 8 so as to obtain a captured image. In this embodiment, the camera 11 is a high-speed camera.

The memory 12 is configured to store a user interface 120, an image recognition module 121, an image calculation module 122, map information 123 that is associated with the golf course 7 (including for instance, location of the green 74), an identification-specification database 124 and a club-carry database 129.

The identification-specification database 124 identification of a particular club, a template of the particular club and a set of club specifications of the particular club.

The club-carry database 129 contains multiple correlations, each between the club specifications of a particular club and a carry of the particular club.

In this embodiment, the display 14 is a projection display including a micro projector 1411 and a prism 1412. The micro projector 1411 is configured to be controlled by the processor 13 to output an image to the prism 1412 so as to project the image onto the retina of the golfer 9. However, embodiment of the display 14 is not limited to the above-mentioned implementation. For example, the display 14 may be a transparent display 142 in a variation of this embodiment as shown in FIG. 2. In FIG. 2, the golfer 9 who wears the wearable augmented reality device 1 of this disclosure is capable of seeing simultaneously actual objects (such as the club 8 the golfer 9 places before his/her eyes) and the image displayed by the transparent display 142 (such as a visual representation 143 of the club specifications determined by the wearable augmented reality device 1 based on the identification 81 of the actual club 8).

In this embodiment, the user interface 120 is operable via the touch module 17, such as a touch pad, a touch switch, etc., by virtue of touch control so as to control the wearable augmented reality device 1. Moreover, the microphone 192 and the loudspeaker 191 enable the golfer 9 to interact with the wearable augmented reality device 1 by virtue of voice control.

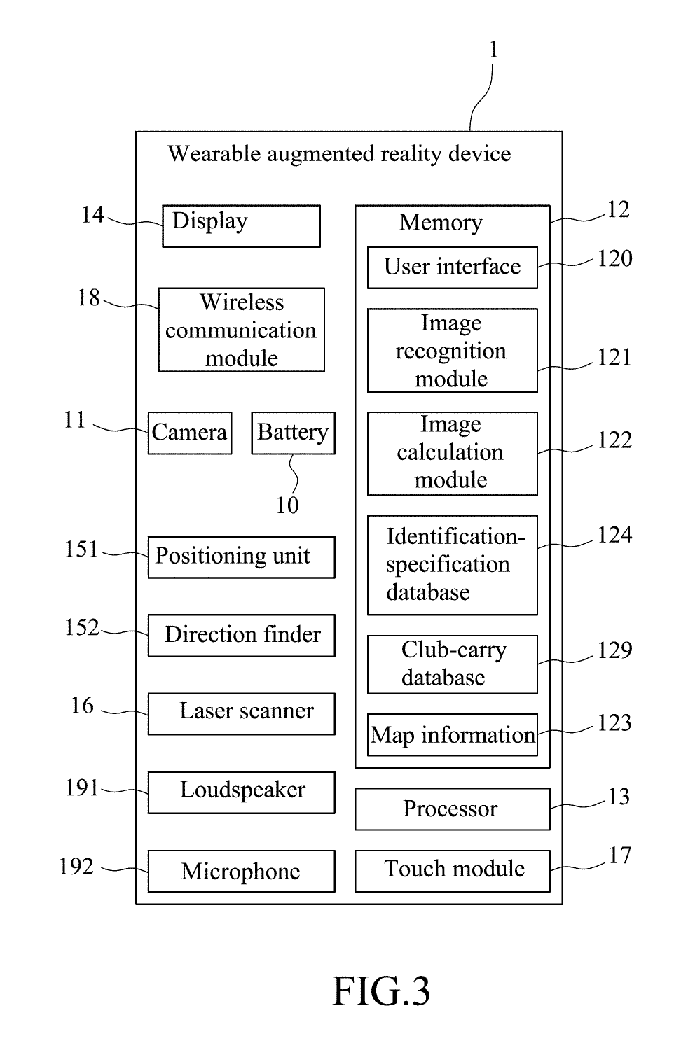

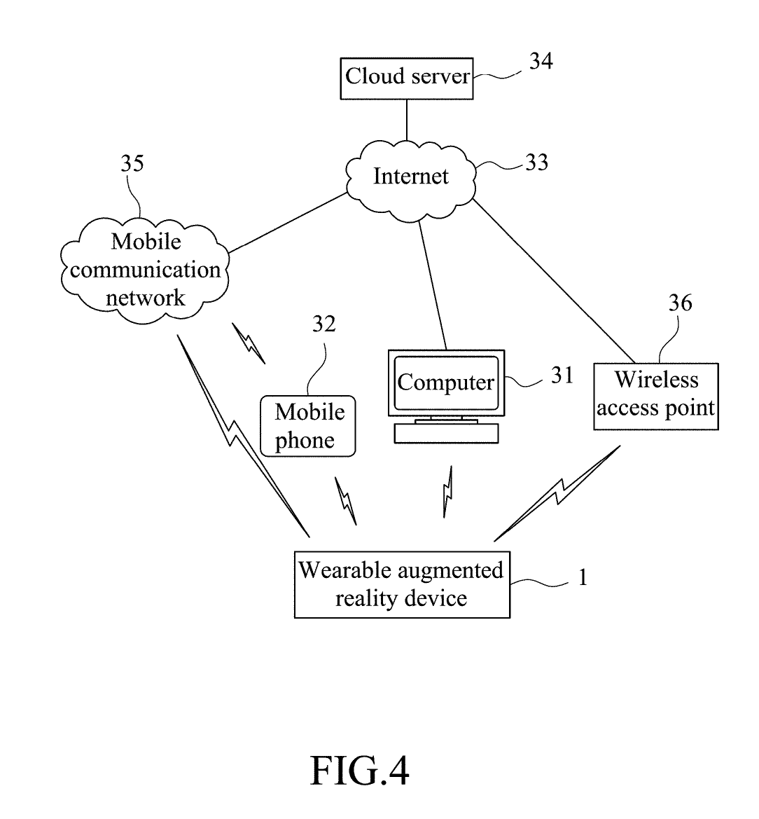

Referring to FIGS. 3 and 4, the wireless communication module 18 is configured to access the Internet 33, so the map information 123 is updatable via the Internet 33 through the wireless communication module 18, which may be a kind of Wi-Fi module or mobile communication module.

Referring to FIGS. 1 to 3, when the golfer 9 operates the user interface 120 by touch control or by voice control and looks at the actual club 8, the camera 11 captures the image of the club 8. The processor 13 executes the image recognition module 121 so as to recognize the identification 81 of the club 8 in the captured image, and executes the image calculation module 122 so as to determine, by comparing the identification 81 thus recognized with the correlations stored in the identification-specification database 124, the club specifications which corresponds to an identification in the identification-specification database 124 the recognized identification 81 of the club 8 matches, and a visual representation of which (labeled 143, exemplified in the form of text) is to be displayed on the display 14. For example, according to the identification-specification database 124, the identification 81, i.e., “56” shown in FIG. 2, of the club 8 is matched by the image calculation module 122 to one of the club specifications “W56”, which corresponds to a 56 degree wedge.

When the identification 81 on the club 8 is unrecognizable, the processor 13 executes the image recognition module 121 so as to recognize an image feature of the club 8 in the captured image, and executes the image calculation module 122 so as to determine, by comparing the image feature thus recognized with the correlations stored in the identification-specification database 124, the club specifications which corresponds to a template in the identification-specification database 124 the image feature of the club 8 matches, and a visual representation 143 of which is to be displayed on the display 14. Therefore, the club specifications of the club 8 can be determined and a visual representation thereof can be displayed by the embodiment of the wearable augmented reality device 1.

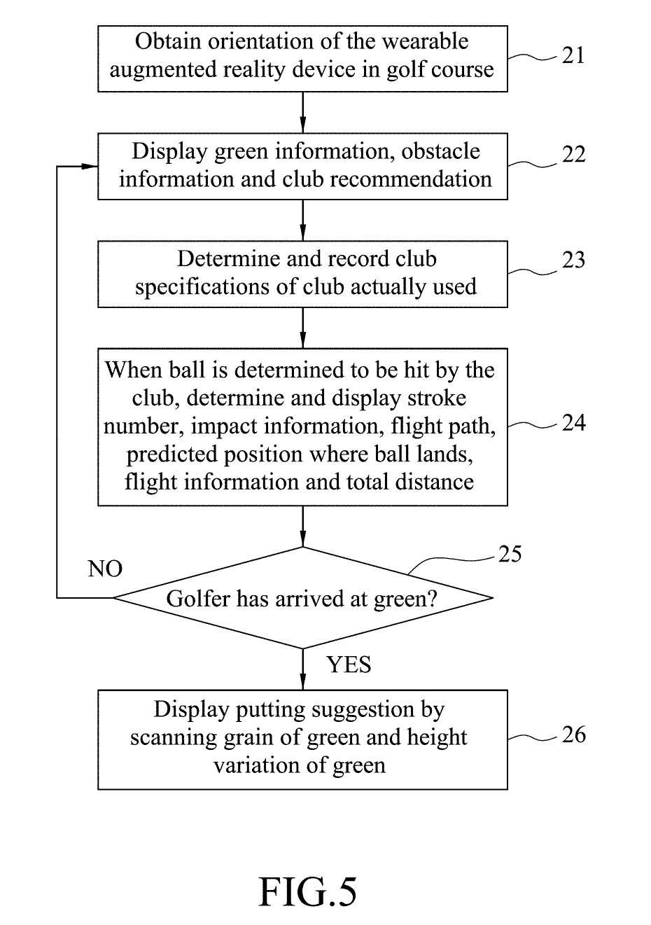

Referring to FIGS. 3, 5 and 6, an operation procedure of using the embodiment of the wearable augmented reality device 1 by the golfer 9 in a golf play is illustrated.

First, in step 21, the positioning unit 151, such as a Global Positioning System (GPS) device, determines geographic position information associated with a position of the wearable augmented reality device 1, and the direction finder 152, such as a compass implemented by a magnetometer, determines geographic direction information associated with a direction of the wearable augmented reality device 1, e.g., a direction in which the wearable augmented reality device faces. The geographic position information, the geographic direction information and the map information 123 enable the wearable augmented reality device 1 to obtain orientation (in terms of position and forward-facing direction) of the wearable augmented reality device 1 with respect to the golf course 7. The processor 13 is further configured to output, according to the geographic position information, the geographic direction information and the map information 123, a message which indicates the orientation of the wearable augmented reality device 1 with respect to the golf course 7 and which is to be displayed on the display (not illustrated).

In step 22, the processor 13 is further configured to generate, according to the geographic position information, the geographic direction information and the map information 123, green information 144 associated with the green 74 in the golf course 7 that is ahead of the golfer 9, obstacle information 145 associated with an obstacle 75 in the golf course 7, and a club recommendation 149 of club specifications associated with a club suitable for a current shot. The processor 13 outputs the green information 144, the obstacle information 145 and the club recommendation 149 to the display 14 to be displayed thereon. It is worth to note that the club-carry database 129 stored in the memory 12 is established specifically for an individual golfer. Each time when the individual golfer uses the wearable augmented reality device 1 for assistance with a shot, the wearable augmented reality device 1 records statistically the club specifications of the club 8 used for the shot actually taken and the corresponding carry, and updates accordingly the club-carry database 129. Therefore, specifically, the processor 13 generates the club recommendation according to an educated club-carry database 129, the geographic position information, the geographic direction information and the map information.

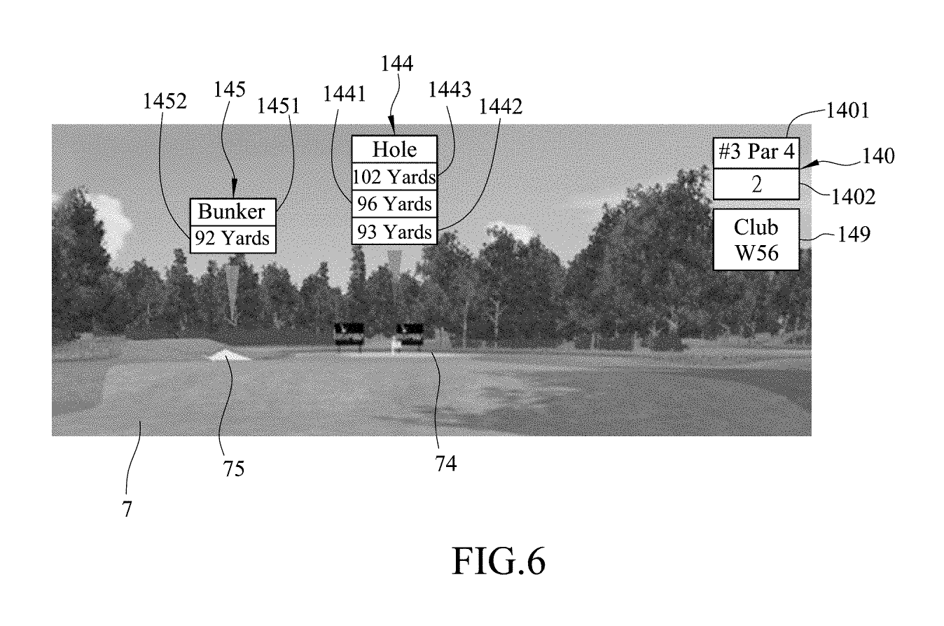

Referring to FIG. 6, in this embodiment, the green information 144 includes a green center distance 1441 (e.g., a distance from a current position of the wearable augmented reality device 1 to a center of the green 74), a green front distance 1442 (e.g., a distance from the current position to a front edge of the green 74) and a green back distance 1443 (e.g., a distance from the current position to a back edge of the green 74). The obstacle information 145 includes an obstacle type 1451 (such as “Bunker” shown in FIG. 6) and an obstacle distance 1452 (e.g., a distance from the current position to the obstacle). In addition, a performance indication 140 associated with performance of the golfer 9 so far is displayed on the display 14 as well. The performance indication 140 includes a par information 1401 and a stroke number 1402. For example, in FIG. 6, the par information 1401 indicates that a current hole number 3 is a par-four hole, i.e., four strokes are expected to complete the hole, and the stroke number 1402 indicates that the golfer 9 has played two strokes at the current hole number 3.

Referring to FIGS. 3, 5 and 7, in step 23, the wearable augmented reality device 1 captures the image of the club 8 actually being used by the golfer 9, determines the club specifications of the club 8 based on the captured image, records the club specifications thus determined, and displays a visual representation 143 of the club specifications on the display 14.

In step 24, the camera 11 captures an image of the ball and the club 8 which is swung by the golfer 9 for hitting the ball. Then, the processor 13 executes the image recognition module 121 so as to recognize the ball and the club 8 in the captured image, and executes the image calculation module 122 so as to determine whether the ball is hit by the club 8 according to a positional relationship between the ball and the club 8 in the captured image. When it is determined by the processor 13 that the ball is hit by the club 8, the processor 13 increases the stroke number 1402 by one and outputs the updated stroke number 1402 to the display 14 for displaying the same (see FIG. 6). In addition, when it is determined that the ball is hit by the club 8, the processor 13 calculates impact information, a flight path 146 of the ball, a predicted position 1461 where the ball lands, and further calculates flight information 147 and a total distance 148 of the ball (i.e., a sum of the carry and a run of the ball) according to the flight path 146 and a rotation of the ball.

Subsequently, the processor 13 outputs the impact information, the predicted position 1461, the flight information 147 and the total distance 148 to the display 14 for displaying the same. The predicted position 1461 is provided to the golfer 9 for the ease of finding the ball. The impact information includes a face angle when the ball is hit by the club 8, a club path, and an attack angle (not shown).

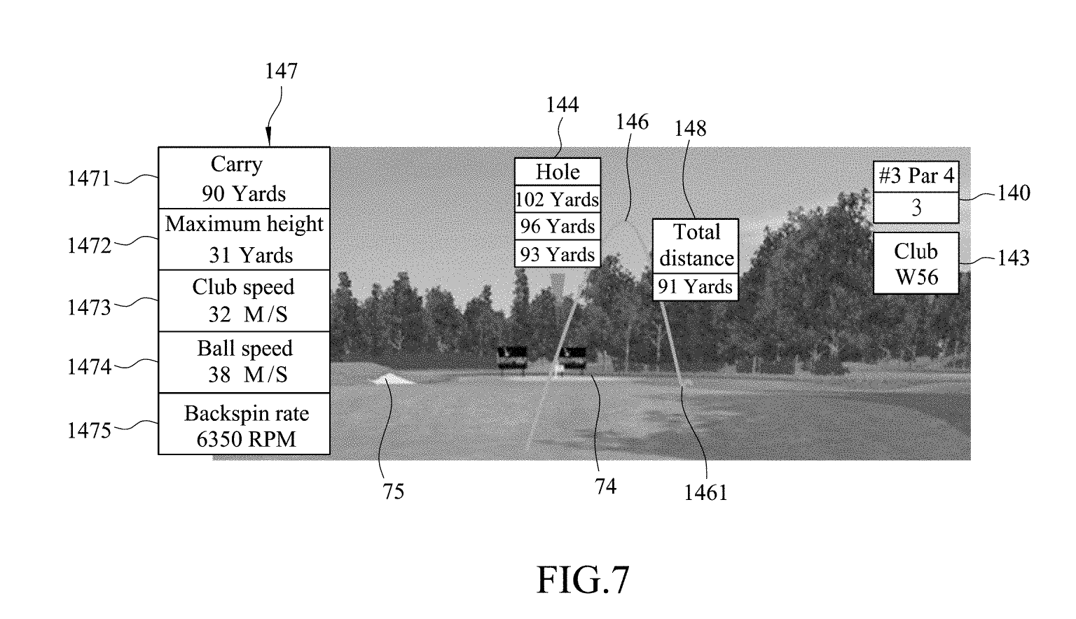

As shown in FIG. 7, the flight information 147 includes the carry 1471, a maximum height 1472, a club speed 1473, a ball speed 1474, and a backspin rate 1475.

In step 25, the processor 13 determines whether or not the golfer 9 has arrived at the green 74 based on the geographic position information obtained by the position unit 151 and the map information 123 stored in the memory 12 (see FIG. 3). When it is determined that the golfer 9 has not arrived at the green 74, the flow goes back to step 22 so as to repeat steps 22-25. Contrastingly, when it is determined that the golfer 9 has arrived at the green 74, the flow of the operation procedure proceeds to step 26.

In step 26, the laser scanner 16 outputs a scanning result by scanning a grain of the green 74 and a height variation of the green 74. Furthermore, the processor 13 executes the image recognition module 121 so as to generate a green recognition result associated with the grain and the height variation of the green 74 according to the scanning result, and executes the image calculation module 122 so as to calculate, according to the green recognition result, a putting suggestion which is associated with a putting direction and a putting force of a putting stroke to be used on the green 74 and which is to be displayed on the display 14 (not shown).

Referring to FIGS. 3 and 4, the wearable augmented reality device 1 is communicable with a cloud server 34 by establishing a connection to the cloud server 34 via one of a computer 31, a mobile phone 32, a wireless access point 36 and a mobile communication network 35, and thereby the wearable augmented reality device 1 or other electronic devices are capable of being utilized to look up the data associated with previous golf play (s) on the cloud server 34. For instance, the wireless communication module 18 may establish the connection to the cloud server 34 by accessing the Internet 33 via the mobile communication network 35, or may establish the connection to the cloud server 34 by accessing the Internet 33 via the computer 31, the wireless access point 36, or the mobile phone 32 in combination with the mobile communication network 35. In other words, the wearable augmented reality device 1 may have mobile Internet access capability, or may have capability for short-range wireless communication, such as Wi-Fi, Bluetooth, and so forth.

In summary, the wearable augmented reality device 1 of this disclosure assists the golfer 9 during a golf play. By cooperation of the camera 11, the image recognition module 121, the image calculation module 122, the display 14 and the laser scanner 16, the wearable augmented reality device 1 is capable of displaying, on the display 14, a visual representation 143 of the club specifications, which is obtained from the identification 81 or the image feature of the club 8, the flight information 147 of the ball, and the putting suggestion.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A wearable augmented reality device for golf play, said wearable augmented reality device assisting a golfer who plays golf with a ball and a club, and comprising:
a camera configured to capture an image of the ball and the club which is swung by the golfer for hitting the ball so as to obtain a captured image;
a memory configured to store an image recognition module and an image calculation module;
a processor configured to execute said image recognition module so as to recognize the ball and the club in the captured image, to execute said image calculation module so as to determine whether the ball is hit by the club according to a positional relationship between the ball and the club in the captured image, to calculate flight information of the ball when it is determined that the ball is hit by the club, and to output the flight information; and
a display configured to receive the flight information from said processor and to di splay the flight information.

2. The wearable augmented reality device as claimed in claim 1, the golfer playing at a golf course, said wearable augmented reality device further comprising:
a positioning unit configured to determine geographic position information associated with a position of said wearable augmented reality device; and
a direction finder configured to determine geographic direction information associated with a direction of said wearable augmented reality device;
wherein said memory is further configured to store map information that is associated with the golf course; and
wherein said processor is further configured to output, according to the geographic position information, the geographic direction information and the map information, a message which indicates orientation of said wearable augmented reality device with respect to the golf course and which is to be displayed on said display.

3. The wearable augmented reality device as claimed in claim 2, wherein said processor is further configured to generate, according to the geographic position information, the geographic direction information and the map information, green information associated with a green in the golf course, obstacle information associated with an obstacle in the golf course, and a club recommendation of club specifications of a club suitable for a current shot, and to output the green information, the obstacle information and the club recommendation to said display to be displayed thereon.

4. The wearable augmented reality device as claimed in claim 3, wherein:
said memory is further configured to store a club-carry database containing at least one correlation between a set of club specifications and a carry;
said processor is further configured to generate the club recommendation according to the club-carry database, the geographic position information, the geographic direction information and the map information.

5. The wearable augmented reality device as claimed in claim 1, wherein said camera is a high-speed camera.

6. The wearable augmented reality device as claimed in claim 1, wherein said display is a transparent display.

7. The wearable augmented reality device as claimed in claim 1, wherein said display is a projection display including a micro projector and a prism.

8. The wearable augmented reality device as claimed in claim 1, wherein when it is determined by said processor that the ball is hit by the club, said processor increases a stroke number by one and outputs the stroke number to said display for displaying the same.

9. The wearable augmented reality device as claimed in claim 1, wherein said processor is further configured to calculate impact information that includes a face angle when the ball is hit by the club, a club path and an attack angle, and to output the impact information to said display for displaying the same.

10. The wearable augmented reality device as claimed in claim 1, wherein the flight information includes at least one of a carry, a maximum height, a club speed, a ball speed, or a backspin rate.

11. The wearable augmented reality device as claimed in claim 1, wherein said processor is further configured to calculate a predicted position where the ball lands, and to output the predicted position to said display for displaying the same.

12. The wearable augmented reality device as claimed in claim 1, the golfer playing at a golf course which includes a green, further comprising:
a laser scanner configured to output a scanning result by scanning a grain of the green and a height variation of the green;
wherein said processor is further configured to execute said image recognition module so as to generate a green recognition result associated with the grain and the height variation of the green according to the scanning result, and to execute said image calculation module so as to calculate, according to the green recognition result, a putting suggestion which is associated with a putting direction and a putting force of a putting stroke to be taken on the green, said processor outputting the putting suggestion to said display to be displayed thereon.

13. The wearable augmented reality device as claimed in claim 1, wherein:
said memory is further configured to store an identification-specification database containing at least one correlation between an identification of the club, a template of the club and club specifications of the club; and
said processor is further configured to execute said image recognition module so as to recognize one of the identification and an image feature of the club in the captured image, and to execute said image calculation module so as to determine, by comparing said one of the identification and the image feature thus recognized with the identification or the template in the identification-specification database, the club specifications which is to be outputted to said display thereby for display on said display.

14. The wearable augmented reality device as claimed in claim 1, further comprising:
a touch module;
wherein said memory is further configured to store a user interface operable via said touch module by virtue of touch control.

15. The wearable augmented reality device as claimed in claim 1, further comprising a microphone and a loudspeaker, said microphone and said loudspeaker enabling the golfer to interact with said wearable augmented reality device by virtue of voice control.

16. The wearable augmented reality device as claimed in claim 1, the golfer playing at a golf course, said wearable augmented reality device further comprising:
a wireless communication module configured to access the Internet;
wherein said memory is further configured to store map information that is associated with the golf course and that is updatable via the Internet through said wireless communication module.

17. The wearable augmented reality device as claimed in claim 1, communicable with a cloud server via a mobile communication network, said wearable augmented reality device further comprising:
a wireless communication module configured to establish a connection to the cloud server by accessing the Internet via the mobile communication network.

18. The wearable augmented reality device as claimed in claim 1, communicable with a cloud server via a mobile communication network, said wearable augmented reality device further comprising:
a wireless communication module configured to establish a connection to the cloud server via one of a computer, a mobile phone and a wireless access point.
